(19) United States
(12) Patent Application Publication
(10) Pub. No.: US 2026/0010413 A1
(43) Pub. Date: Jan. 8, 2026

(54) AUTO-SCALING COMPUTING RESOURCE INSTANCES OF A SERVICE FOR A PREDICTED WORKLOAD

(71) Applicant: ADOBE INC., San Jose, CA (US)

(72) Inventors: Haoliang WANG, Sunnyvale, CA (US); Hao LIN, Santa Clara, CA (US); Ashish MEHTA, Milpitas, CA (US); Miao WANG, Mountain View, CA (US); Hitesh Shashikant SHAH, Mountain View, CA (US); Sapthotharan Krishnan NAIR, Santa Clara, CA (US)

(21) Appl. No.: 18/762,293

(22) Filed: Jul. 2, 2024

(51) Int. Cl. G06F 9/50; G06F 11/34

(52) U.S. Cl. CPC G06F 9/5083; G06F 9/5044; G06F 11/3452

(57) ABSTRACT

Methods and systems are provided for auto-scaling computing resource instances of a service for a predicted workload. In embodiments described herein, a predicted incoming data processing workload for a service of a cloud computing system is determined based on incoming data traffic. A predicted quality of service (QOS) metric of the service that is below a QoS metric threshold is determined based on the predicted incoming data processing workload and a number of computing resource instances of a current configuration of the service. A new number of computing resource instances of the service where a corresponding predicted QoS metric is above the QoS metric threshold is determined based on applying the predicted incoming data processing workload and the QoS metric threshold to a search algorithm. The service is auto-scaled based on the new number of computing resource instances.

### BACKGROUND

Auto-scaling is a cloud computing feature that adjusts the number of computing resource instances, such as virtual machines (VMs) or containers, based on the real-time state of the cloud computing system to optimize performance and cost efficiency when implementing services. Central processing unit (CPU) utilization, which measures the percentage of computational power used by a VM or container, and queue depth, the count of tasks waiting to be processed, are metrics utilized for auto-scaling policies to determine when to adjust the number of computing resource instances. For example, when CPU utilization or queue depth exceeds a preset threshold, the system automatically increases the number of VMs or containers. Conversely, when CPU utilization or queue depth decreases below a preset threshold, the auto-scaling policy of the system reduces the number of VMs or containers.

### SUMMARY

Various aspects of the technology described herein are generally directed to systems, methods, and computer storage media for, among other things, auto-scaling computing resource instances of a service for a predicted workload. In this regard, embodiments described herein facilitate determining the optimal number of computing resource instances of a service to comply with a given quality service metric based on a predicted workload in order to dynamically adjust the number of computing resource instances. For example, an incoming data processing workload, such as an incoming data ingestion workload is predicted. In some embodiments, the incoming data processing workload is predicted using a hierarchical time-series forecasting method. In some embodiments, external data can be used in addition to the incoming data traffic to predict the incoming data processing workload. Using the predicted incoming data processing workload, a quality of service (QOS) metric, such as latency, of the service (e.g., or multiple services) can be predicted based on the number of computing resource instances of the service. In some embodiments, the QoS metric can be predicted using a queuing model that models the arrival process and service process of incoming data traffic by the number of computer resource instances of the service using probability distributions. In some embodiments, the QoS metric can be predicted using a regression model, such as a Histogram-Based Gradient Boosting Regression Tree (HGBR). The number of computing resource instances of the service (e.g., or multiple services) can be dynamically adjusted to comply with a given QoS metric based on the predicted incoming data processing workload. In some embodiments, a search algorithm is used to determine the optimal number (e.g., or near optimal within a threshold) of computing resource instances of the service that complies with the given QoS metric, such as by using a brute-force configuration search and/or a search optimization technique, such as a combinatorial search algorithm (e.g., hill climbing, beam search, simulated annealing, genetic algorithms, open-loop control and oscillation, and/or others).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram of determining the optimal number of computing resource instances of the service in order to auto-scale computing resource instances of a service for a predicted workload, in accordance with embodiments of the present disclosure.

FIG. 4A provides an example diagram of hierarchal time-series levels of a hierarchal time-series forecasting method, in accordance with embodiments of the present disclosure.

FIG. 4B provides an example diagram of an incoming data ingestion workload of hierarchal time-series levels of FIG. 4A, in accordance with embodiments of the present disclosure.

FIG. 4C provides an example diagram of a predicted incoming data ingestion workload with respect to the ground truth incoming data ingestion workload of FIG. 4B, in accordance with embodiments of the present disclosure.

FIG. 5A provides an example diagram of a queuing model, in accordance with embodiments of the present disclosure.

FIG. 5B provides an example diagram of a predicted latency of a service based on the number of computing resource instances of the service and the predicted incoming data ingestion workload of FIG. 4C with respect to the ground truth latency, in accordance with embodiments of the present disclosure.

FIG. 6 provides an example diagram of determining the optimal number of computing resource instances of the service based on a given QoS metric in order to auto-scale computing resource instances of a service for a predicted workload, in accordance with embodiments of the present disclosure.

FIG. 7 is a process flow showing a method for auto-scaling computing resource instances of a service for a predicted workload, in accordance with embodiments of the present disclosure.

FIG. 8 is a process flow showing a method for auto-scaling computing resource instances of a service for a predicted workload by determining the optimal number of computing resource instances of a service that comply with a given quality service metric based on the predicted workload, in accordance with embodiments of the present disclosure.

FIG. 9 is a block diagram of an example computing device in which embodiments of the present disclosure can be employed.

### DETAILED DESCRIPTION

Cloud computing systems generally run services, such as by storing data or running one or more portions of an application, in a distributed manner. The terms “application” or “service” are used interchangeably, and broadly refer to any software, or portions of software, that run on top of, or access storage and computing device locations within, a datacenter. For example, cloud computing systems can run one or more portions of a service for a tenant, such as web services (e.g., delivering web content, etc.), microservices (e.g., for authentication, payment processing, etc.), database services (e.g., to distribute query loads, etc.), application services (e.g., e-commerce, real-time data streaming and processing, etc.) and/or others. A tenant can refer to a customer utilizing resources of cloud computing system. A cloud computing system that supports multiple tenants can be referred to as a multi-tenant infrastructure.

Auto-scaling is a cloud computing feature that adjusts the number of computing resource instances, such as VMs or containers, based on the real-time state of the cloud computing system to optimize performance and cost efficiency when implementing services. CPU utilization, which measures the percentage of computational power used by a VM or container, and queue depth, the count of tasks waiting to be processed, are metrics utilized for auto-scaling policies to determine when to adjust the number of computing resource instances. For example, when CPU utilization or queue depth exceeds a preset threshold, the system automatically increases the number of VMS or containers. Conversely, when CPU utilization or queue depth decreases below a preset threshold, the auto-scaling policy of the system reduces the number of VMs or containers.

A Service Level Agreement (SLA) is a formal document that defines the level of service expected from a service provider, outlining QoS metrics by which service is measured and the remedies or penalties if agreed-upon service levels are not achieved. QoS metrics, such as latency, throughput, error rate, and/or others, are important metrics to engineers and users of a service, such as customers, as QoS metrics correspond to the customer experience with the service. QOS metrics in an SLA typically fall into categories of performance, availability, and reliability. Performance metrics measure the responsiveness and speed of a service, including latency (e.g., the time it takes for a data packet to start being transferred after an instruction is issued), throughput (e.g., the volume of data successfully processed or transferred within a specific timeframe), and average wait time (e.g., the typical duration a user or system waits before a service request is processed). Availability metrics assess how often a service is operational and accessible, often expressed as a percentage. Reliability metrics focus on the consistency and dependability of a service, with measures such as error rates, which count the number of failures over a specified period, and mean time between failures (MTBF), indicating the average time between service disruptions.

The backend system level metrics of the cloud computing infrastructure, such as CPU utilization, graphic processing unit (GPU) utilization, random access memory (RAM) utilization, and queue depth, are typically not included in the SLA as the backend system level metrics of the cloud computing infrastructure do not directly correspond to the customer experience with the service. In this regard, the backend system level metrics of the cloud computing infrastructure, such as CPU utilization and queue depth, used by the auto-scaler often do not reflect the actual performance the corresponding service is delivering. For example, high CPU utilization does not necessarily mean a high latency above the threshold defined in the SLA. As such, even if an engineer manually derived a mapping between CPU utilization of an instance and a QoS metric to comply with an SLA, the mapping will need to be manually updated each time any changes are made to the service, such as code changes, hardware changes, and/or any other changes.

Further, as prior auto-scaling policies only rely on the real-time state of the cloud computing system, the cloud computing system can take a significant amount of time to launch new instances for a service, such as by launching a new container or provisioning a new underlying VM and then launching the VM. Thus, in situations where incoming traffic changes rapidly, by the time the auto-scaling technique implements a decision to launch new instances based on the current observed states of the system (e.g., CPU utilization is above a threshold), the decision may already be obsolete due to reduced traffic, thereby reducing efficiency and performance. Additionally, by the time the auto-scaling technique launches the new instances, the traffic may have exceeded the processing capabilities of the preceding number of instances, thereby reducing efficiency and performance.

Even further, prior auto-scaling policies are only capable of auto-scaling each service independently (e.g., each web service, micro-service, database service, application service and/or others are auto-scaled independently from others). As an example, a request may go through multiple micro-services before it is processed and returned to the user. When traffic spikes, the auto-scaling policy will use the real-time data to auto-scale the first micro-service and will not auto-scale the next micro-service until after the request passes from the first micro-service to the next micro-service. Thus, the auto-scaling of each micro-service independently will cause a delay as it will take a significant amount of time to scale up each micro-service as a traffic spike sequentially proceeds through each of the micro-services, thereby reducing performance and efficiency.

Accordingly, unnecessary computing resources are utilized to apply auto-scaling policies in conventional implementations. For example, computing and network resources are unnecessarily consumed (e.g., due to the increase in computer input/output operations) when auto-scaling policies only rely on the real-time state to scale computing resource instances as the auto-scaling policy may unnecessarily launch new instances as the data traffic may have subsided by the time the new instances are launched by the auto-scaling policy. Further, the delays caused by processing of operations to launch new instances when auto-scaling policies only rely on the real-time state to scale computing resource instances and/or when auto-scaling policies only auto-scale services independently increases the network latency as traffic can exceed the data processing capabilities of the number of instances before the new instances are launched. As well, computing and network resources would be unnecessarily consumed (e.g., due to the increase in computer input/output operations) to facilitate an engineer to manually derive and manually update a mapping between CPU utilization of an instance and a QoS metric to comply with an SLA.

As such, embodiments of the present disclosure are directed to auto-scaling computing resource instances of a service for a predicted workload in an efficient and effective manner. In this regard, the number of computing resource instances of a service can be dynamically adjusted to comply with a given QoS metric based on a predicted workload. In this way, the reliability of the service complying with the given QoS metric for the predicted workload is increased while decreasing the computational cost of unnecessarily launching new instances, decreasing the network latency introduced by delays in launching new instances by only relying on real-time data and only auto-scaling services independently, and decreasing the computational cost of manually deriving and manually updating a mapping between CPU utilization and the given QoS metric.

Generally, and at a high level, embodiments described herein facilitate auto-scaling computing resource instances of a service for a predicted workload. In particular, embodiments described herein facilitate determining the optimal number of computing resource instances of a service to comply with a given quality service metric based on a predicted workload in order to dynamically adjust the number of computing resource instances. For example, an incoming data processing workload, such as an incoming data ingestion workload is predicted. In some embodiments, the incoming data processing workload is predicted using a hierarchical time-series forecasting method. For example, the hierarchal time-series forecasting method can detect incoming data traffic and predict the incoming data processing workload using a number of hierarchal time-series levels, where one hierarchal time-series level is based on individual data sources, one hierarchal time-series level for each tenant, and one hierarchal time-series level for the total traffic of the service and/or a data resource grouping (e.g., live data, backfill data, etc.). Each of the hierarchal time-series levels are reconciled into the hierarchal time-series level for the total traffic of the service and/or data resource grouping. In some embodiments, external data can be used in addition to the incoming data traffic to predict the incoming data processing workload. For example, data regarding traffic from upstream services, such as interconnected microservices, and/or other external data of the tenant, such as historical data or calendar data, can be used in addition to the incoming data traffic to predict the incoming data processing workload.

Using the predicted incoming data processing workload, a QoS metric, such as latency, of the service (e.g., or multiple services) can be predicted based on the number of computing resource instances of the service. In some embodiments, the QoS metric can be predicted using a queuing model that models the arrival process and service process of incoming data traffic by the number of computer resource instances of the service using probability distributions. In some embodiments, the QoS metric can be predicted using a regression model, such as a HGBR.

The number of computing resource instances of the service (e.g., or multiple services) can be dynamically adjusted to comply with a given QoS metric based on the predicted incoming data processing workload. For example, if the predicted QoS metric is below the given QoS metric threshold, the number of computing resource instances of the service can be increased to meet or exceed the given QoS metric threshold. If the predicted QOS is above the given QoS metric threshold, the number of computing resource instances of the service can be decreased while still meeting or exceeding the given QoS metric threshold to decrease computational costs. In some embodiments, a search algorithm is used to determine the optimal number (e.g., or near optimal within a threshold) of computing resource instances of the service that complies with the given QoS metric, such as by using a brute-force configuration search and/or a search optimization technique, such as a combinatorial search algorithm (e.g., hill climbing, beam search, simulated annealing, genetic algorithms, open-loop control and oscillation, and/or others).

In operation, an incoming data processing workload is predicted. Any known prediction technique can be used to predict the incoming data processing workload. In some embodiments, the incoming data processing workload is predicted using a hierarchical time-series forecasting method using historical data traffic. The hierarchical time-series forecasting method is used to predict future values across multiple levels of aggregation within a hierarchical structure, such as through a top-down, bottom-up, middle-out, and/or a reconciliation approach. In the top-down approach, forecasting begins at the top, most aggregated level of the hierarchy (e.g., the data traffic of the service), and these forecasts are then disaggregated to lower levels (e.g., in the order of the data traffic of (1) each data resource grouping, (2) each tenant, and/or (3) each data source of each tenant). Conversely, the bottom-up approach starts at the most granular level (e.g., the data traffic of each data source of each tenant), with forecasts subsequently aggregated to higher levels (e.g., until the top, most aggregated level of the hierarchy of the data traffic coming into the service). The middle-out method initiates forecasting from an intermediate level, adjusting forecasts both upwards and downwards through the hierarchy. Generally, reconciliation approaches initially generate independent forecasts at various levels and then adjusting the independent forecasts at each level to maintain consistency across the hierarchy, such as by utilizing statistical techniques to minimize overall forecasting errors. Any known reconciliation approach can be used to predict the incoming data processing workload.

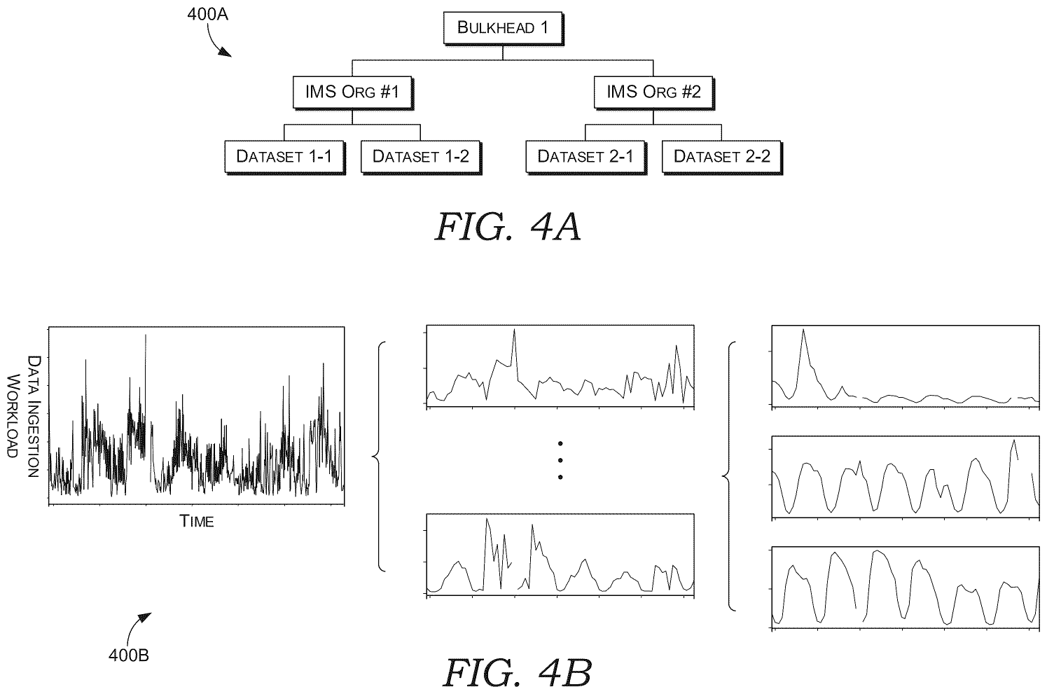

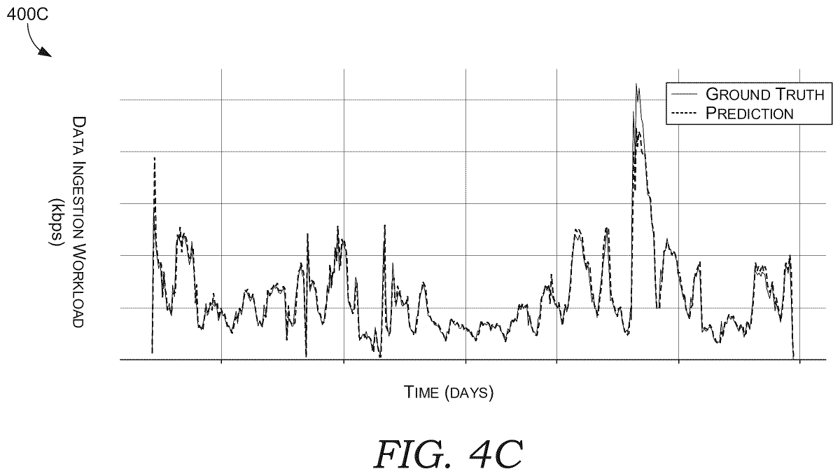

As an example, a multi-tenant infrastructure of a cloud computing system collects an aggregated flow from traffic from multiple tenants. Within each tenant, there are multiple data sources that are generating the data traffic for the data processing workload. In this regard, the hierarchal time-series forecasting method can detect incoming data traffic and predict the incoming data processing workload using a number of hierarchal time-series levels. For example, the hierarchal time-series levels can include a hierarchal time-series level based on individual data sources, a hierarchal time-series level for each tenant, and a hierarchal time-series level for the total traffic of the service. As another example, the hierarchal time-series levels can include a hierarchal time-series level based on individual data sources, a hierarchal time-series level for each tenant, a hierarchal time-series level for each data resource grouping (e.g., live data, backfill data, etc.) of the service, and/or a hierarchal time-series level for the total traffic of the service. As yet another example, the hierarchal time-series levels can include a hierarchal time-series level based on individual data sources, a hierarchal time-series level for each tenant, and a hierarchal time-series level for each data resource grouping of the service (e.g., in order to auto-scale computer resource instances of the portions of the service that facilitate data processing (e.g., ingestion) of each data resource grouping based on the QoS requirements of each data resource grouping). An example of hierarchy of data sources is shown in FIG. 4A. An example of the incoming data ingestion workload of the hierarchy of data sources of FIG. 4A is shown in FIG. 4B.

Each of the hierarchal time-series levels are reconciled into the hierarchal time-series level for the total traffic of the service. Therefore, by utilizing individual time-series of the traffic generated at each level (e.g., as granular as each data source of each tenant), temporal patterns can be detected and/or predicted (e.g., traffic may be generated by periodical jobs and/or based workday/workweek schedule) based on the unique characteristics of each data source, tenant, data resource grouping, and/or tenant.

In some embodiments, a reconciliation approach can be utilized, such as by building the time-series forecasting models independently at each level using a Seasonal Autoregressive Integrated Moving Average with Exogenous Regressors (SARIMAX) model, reconciling the individual forecasts, such as through a regression model (e.g., a linear regression model where individual forecasts are derived as weighted sums of forecasts from all hierarchy levels), and using the harmonized model at the top level to forecast the aggregated traffic of the system will experience in the near future. An example of a predicted incoming data ingestion workload with respect to a ground truth incoming data ingestion workload of FIG. 4B is shown in FIG. 4C.

In some embodiments, a data resource grouping level is used in the hierarchal time-series levels of the hierarchal time-series forecasting method in order to auto-scale computer resource instances of the portions of the service that facilitate data processing of each data resource grouping based on the QoS requirements of each data resource grouping. For example, live data may require a higher latency QoS metric when processing the live data as opposed to backfill data (e.g., live traffic must be ingested within a few hours and backfill data must be ingested within 30 days, so the backfill data can be ingested during off-peak times). Backfill data generally refers to processing historical data, such as data from another system (e.g., a third-party customer relationship management system) that is not provided in real-time and/or to fix the historical data (e.g., remove data from bots as opposed to actual transactions of the tenant).

The data resource groupings can be isolated using data processing partitions, also referred to herein as bulkheads, of the service. In this regard, a different number of computer resource instances of the service may be implemented at each bulkhead of the service to facilitate data processing of each data resource grouping based on the QoS requirements of each data resource grouping. A data processing partition, or bulkhead, generally refers to a software architecture pattern that isolates incoming data traffic based on the data resource grouping, such as isolating live traffic to a live traffic bulkhead, isolating backfill data to a backfill bulkhead, isolating data of a specific tenant to a customer bulkhead (e.g., for a higher priority customer), isolating fault-causing data to a bulkhead that prevents processing of the data into the service, and/or others. Bulkheads can be used to isolate different data resource groupings based on the specific QoS requirements of the data. For example, bulkheads can isolate high-volume transactional data, such as sales transactions or real-time user activity, from analytical processes to prevent the data analysis tasks from slowing down the processing of the transactional data. As another example, bulkheads can used to isolate multimedia content streams (e.g., video, audio) from text data streams to optimize different processing needs and storage handling in content delivery networks. Bulkheads can also be used to isolate different data resource groupings to prevent failure propagation and performance issues across different parts of the system (e.g., which would have higher QoS metrics than other data analysis tasks). For example, a bulkhead can be used to separate critical infrastructure monitoring data from general operational metrics to ensure system stability.

In some embodiments, external data can be used in addition to the incoming data traffic to predict the incoming data processing workload. For example, data regarding traffic from upstream services, such as interconnected microservices, and/or other external data of the tenant, such as historical data or calendar data, can be used in addition to the incoming data traffic to predict the incoming data processing workload. As a more specific example, data regarding the website traffic of a tenant may indicate that the higher volume of transactions are likely to occur, and therefore the predicted incoming data processing workload to process the higher volume of transaction will increase. As another example, breaking news indicating an increased traffic on a news website may indicate that increased video streaming traffic are likely to occur. As yet another example, a tenant's work schedule may indicate when a volume of backfill data is likely to occur based on historically when the volume of backfill data is sent by the tenant. In some embodiments, the external signals can be treated as exogenous variables and directly incorporated into the prediction model, such as the SARIMAX model. In some embodiments, events can be manually input into the system. In some embodiments, a calendar can be converted into a time-series in order for the hierarchal time-series forecasting method to utilize data traffic of previous events (e.g., similar events) to predict the data processing workload of future events. For example, a calendar with an indication of a major sporting event can providing an indication that streaming traffic will increase for a streaming service.

Using the predicted incoming data processing workload, a QoS metric, such as latency, throughput, and/or other QoS metrics, of the service (e.g., or multiple services) can be predicted based on the number of computing resource instances of the service. Any known prediction technique can be used to predict the performance of the system based on the number of computing resource instances of the service.

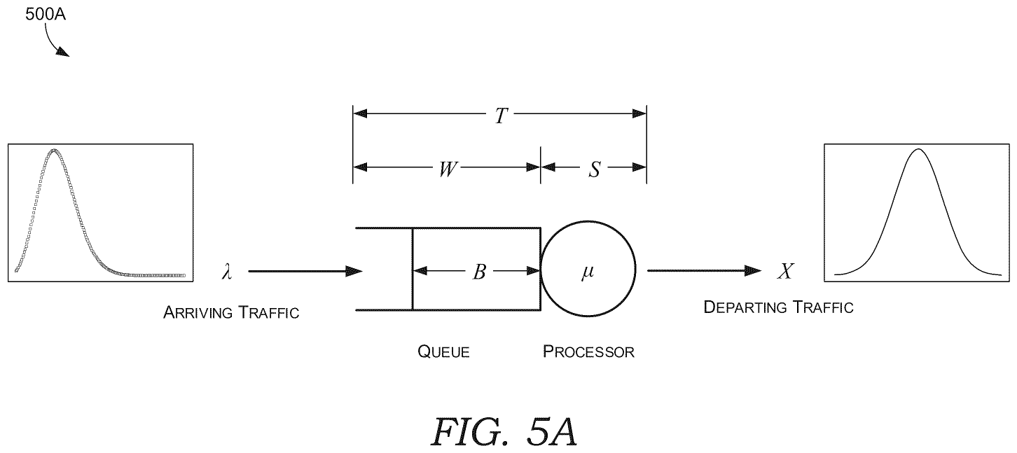

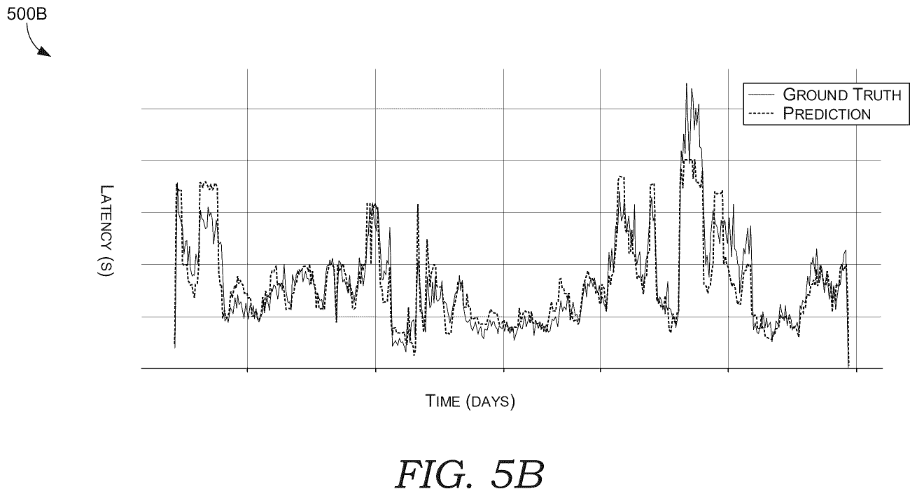

In some embodiments, the QoS metric can be predicted using a queuing model that models the arrival process and service process of incoming data traffic by the number of computer resource instances of the service using probability distributions determined from historical data traffic and QoS measurements. An example of a queuing model is shown in FIG. 5A. As can be understood, a queuing model of an abstraction of queue and processors is used to represent the various components inside the systems (e.g., CPU, and Network I/O). The system can then be analyzed using queuing theory.

For example, the queuing model can model an arrival process representing how traffic enter the system over time, such as by using probability distributions to describe the inter-arrival times between entities. The queuing model can model a service process representing how traffic are processed or served by the system, such as by using probability distributions to describe the service times for entities. The queuing model can model queue discipline that determines the order in which entities are served from the waiting line, such as whether the queue discipline uses First-In-First-Out (FIFO), Last-In-First-Out (LIFO), Priority Queuing, etc. The queuing model can model the number of servers or service facilities in the system (e.g., more servers generally reduces wait times and improves system throughput). The queuing model can model queue capacity representing the maximum number of entities that can be accommodated in the waiting line or queue before the entities are turned away or blocked. The queuing model can model can use queuing theory to determine various performance metrics to evaluate the system's efficiency and effectiveness, including average waiting time, average queue length, system throughput, utilization rate of servers, and probability of waiting. With respect to FIG. 5A, B generally refers to an estimation of the backlog of queue, u generally refers to an estimation of the processing speed, W generally refers to an estimation of waiting time, S generally refers to an estimation of processing time, and T generally refers to an estimation of total latency. In some embodiments, the variables are determined by studying the characteristics of the system. In some embodiments, the variables are determined by fitting the arrival/departure traffic to a stochastic process (e.g., Poisson process).

In some embodiments, the QoS metric can be predicted using a regression model determined (e.g., trained using) from historical data traffic and QoS measurements. Any known regression model can be used to predict the QoS metric. In some embodiments, HGBR is used to predict the QoS metric based on the number of computing resource instances of the service. HGBR is a machine learning technique that uses decision tree ensembles for regression tasks through gradient boosting and histogram-based binning techniques to achieve faster training times and improved predictive performance. Generally, HGBR is based on gradient boosting, which is an ensemble learning method that builds an ensemble of weak learners (e.g., decision tree) sequentially, where each subsequent tree tries to correct the errors made by its predecessors. Histogram-based binning, where input features are binned into histograms during the tree construction process, is introduced in HGBR to reduce the number of feature comparisons during the tree building. For example, a HGBR regressor can be trained to predict the average latency of the system using input variables, such as the size and number of rows of each batch of data, number of computing resource instances of a service per bulkhead, queuing time, utilization, number of in-flight batches, and/or others.

An example of predicting the latency of a service for a data ingestion workload based on the number of computing resource instances of the service with respect to ground truth latency for the number of computing resource instances is shown in FIG. 5B.

The number of computing resource instances of the service (e.g., or the number of computing resource instances each service of multiple services) can be dynamically adjusted to comply with a given QoS metric based on the predicted incoming data processing workload. For example, if the predicted QOS metric is below the given QoS metric threshold, the number of computing resource instances of the service can be increased to meet or exceed the given QoS metric threshold. If the predicted QoS is above the given QoS metric threshold, the number of computing resource instances of the service can be decreased while still meeting or exceeding the given QoS metric threshold to decrease computational costs. In some embodiments, the number of computing resource instances of the service (e.g., or the number of computing resource instances each service of multiple services) can be dynamically adjusted at each bulkhead to comply with a given QoS metric of each bulkhead based on the predicted incoming data processing workload for each bulkhead.

In some embodiments, a search algorithm is used to determine the optimal number (e.g., or near optimal within a threshold) of computing resource instances of the service that complies with the given QoS metric For example, if the given latency limit is 100 ms, the goal of the algorithm is to find the minimum number of computing resource instances that are estimated to process the traffic within 100 ms (e.g., or a threshold amount above of the given latency, such as 50% above the latency). Any known search technique can be used to determine the optimal number of computing resource instances of the service (e.g., or the number of computing resource instances each service of multiple services).

In some embodiments, a brute-force configuration search is used to determine the optimal number of computing resource instances of the service. In some embodiments, a search optimization technique, such as a combinatorial search algorithm (e.g., hill climbing, beam search, simulated annealing, genetic algorithms, open-loop control and oscillation, and/or others), is used to determine the optimal number of computing resource instances of the service. For example, in some embodiments, the search algorithm may only need to determine the QoS for a smaller amount of possible configurations (e.g., only the instances of a single service). Thus, the optimal number of computing resource instances can be determined by the search algorithm using brute force by determining the QoS for all of the configurations. In a different example, in some embodiments, there may be a larger amount of possible configurations (e.g., where the search algorithm determines the number of computing resource instances of each service for multiple services organized in a chain increasing the search space exponentially), so a search optimization technique can be used to determine the optimal number of computing resource instances.

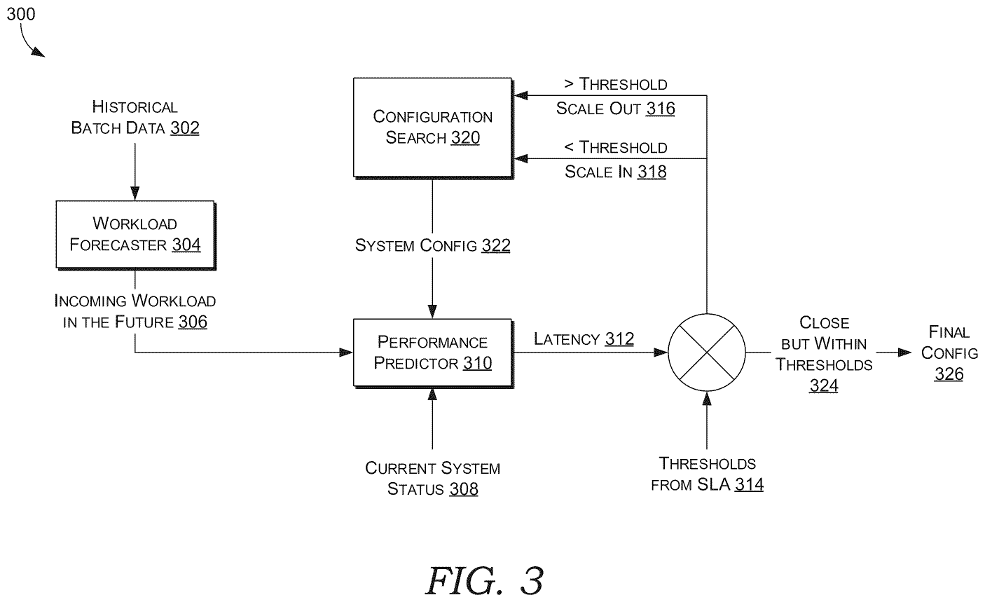

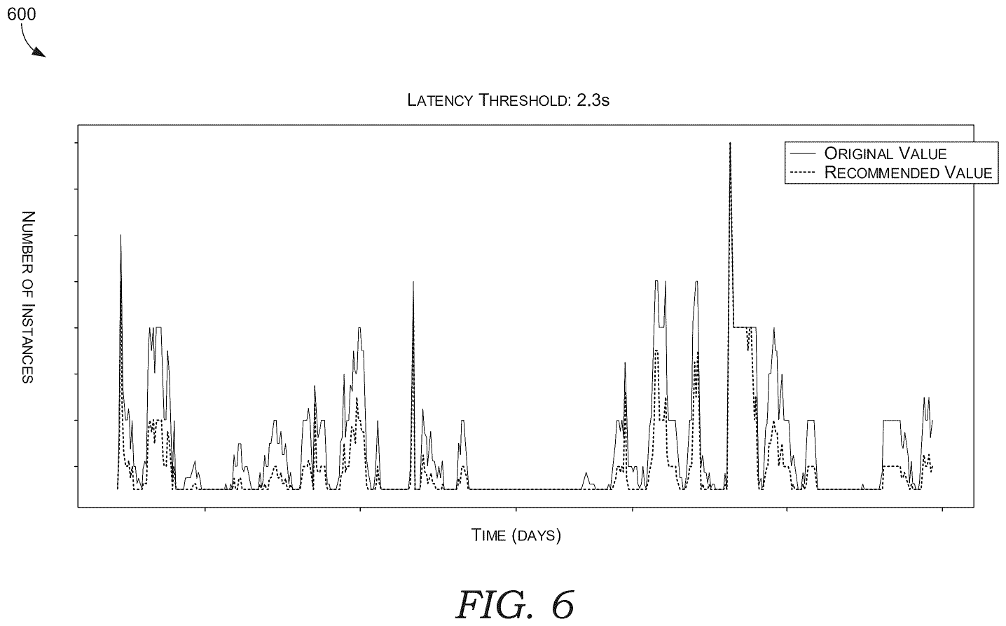

An example diagram of determining the optimal number of computing resource instances of the service is shown in FIG. 3. An example of auto-scaling the number of computing resource instances to comply with a given quality service metric corresponding to a latency of 2.3 seconds based on a predicted workload is shown in FIG. 6.

In some embodiments, the predicted incoming data processing workload is periodically determined (e.g., a query is made to determine the predicted incoming data processing workload every five minutes) in order to dynamically adjust the number of computing resource instances of the service at scheduled periodic intervals. In some embodiments, the optimal number (e.g., or near optimal within a threshold) of computing resource instances of the service is periodically determined (e.g., a query is made to determine the optimal number of computer resource instances every fifteen minutes) in order to dynamically adjust the number of computing resource instances of the service at scheduled periodic intervals with enough time to auto-scale the service before the predicted incoming data processing workload is processed, such as through ingestion. In some embodiments, the predicted incoming data processing workload is determined and/or the optimal number of computing resource instances is determined when incoming data traffic increases by a threshold amount in order to dynamically adjust the number of computing resource instances of the service.

Advantageously, efficiencies of computing and network resources can be enhanced using implementations described herein. In particular, the automated process for auto-scaling computing resource instances of a service for a predicted workload from a predicted incoming data processing workload and predicted performance of the number of instances of the service provides for a more efficient use of computing and network resources (e.g., less operations, higher throughput and reduced latency for a network, less packet generation costs, etc.) than prior methods. For example, using implementations described herein enhances efficiencies of computing and network resources with respect to prior methods of auto-scaling policies that only rely on the real-time state to scale computing resource instances and/or auto-scaling policies that only auto-scale services independently. Further, using implementations described herein enhances efficiencies of computing and network resources with respect to manually deriving and manually updating a mapping between CPU utilization of an instance and a threshold of a QoS metric.

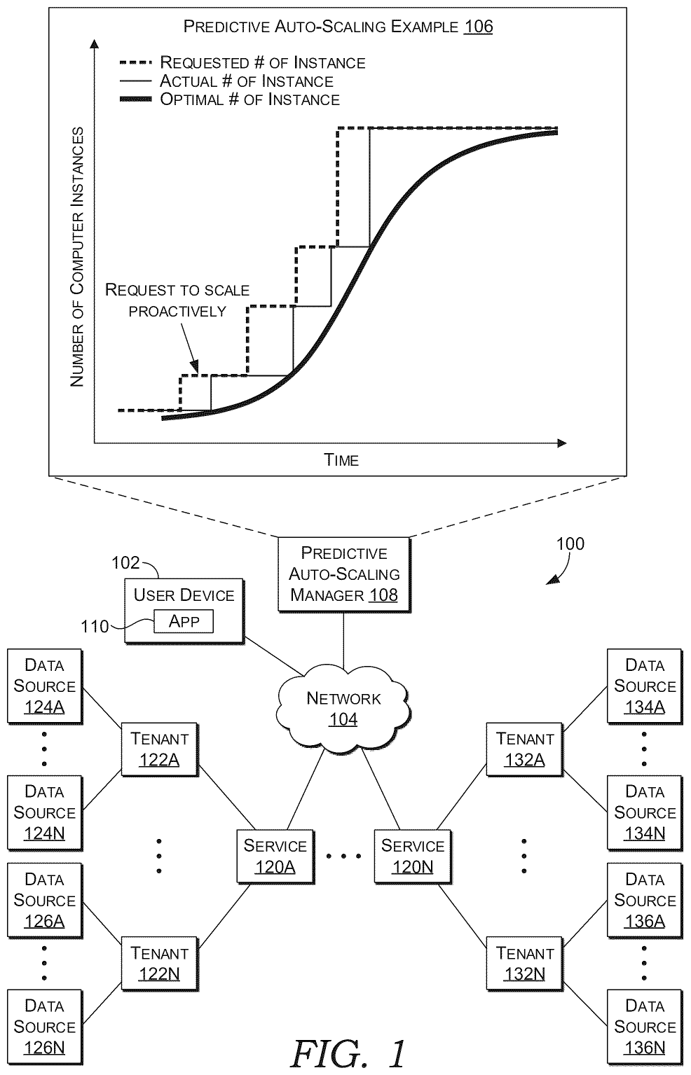

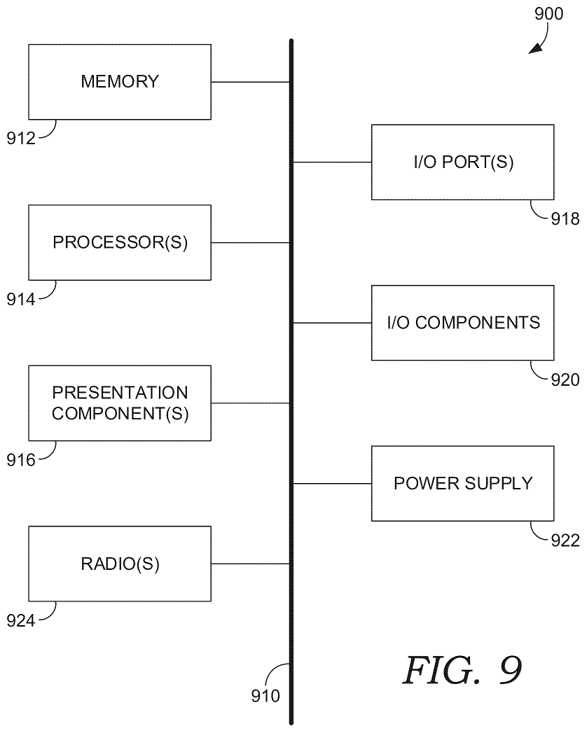

Having provided an overview of the technology described herein, reference is now made to FIG. 1. FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 9.

It should be understood that operating environment 100 shown in FIG. 1 is an example of one suitable operating environment. Among other components not shown, operating environment 100 includes a user device 102, application 110, network 104, and predictive auto-scaling manager 108. Operating environment 100 also shows services 120A-120N of a cloud computing system. Service 120A supports tenants 122A-122N where data is communicated for processing by the service 120A through multiple data sources of the tenant. For example, data is communicated for processing by the service 120A through data sources 124A-124N of tenant 122A and data sources 126A-126N of tenant 122N. Service 120N supports tenants 132A-132N where data is communicated for processing by the service 120N through multiple data sources of the tenant. For example, data is communicated for processing by the service 120N through data sources 134A-134N of tenant 132A and data sources 136A-136N of tenant 122N. Operating environment 100 also shows a predictive auto-scaling example 106. Each of the components shown in FIG. 1 can be implemented via any type of computing device, such as one or more of computing device 900 described in connection to FIG. 9, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., an engineer implementing the predictive auto-scaling manager 108, a user interacting with services 120A-N through application 110, etc.). For example, in some implementations, such devices are the type of computing device described in relation to FIG. 9. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

In some implementations, application 110 operating on user device 102 can generally be an application that allows an engineer to implement the predictive auto-scaling manager 108 for a service of a cloud computing system, such as services 120A-N. In some implementations, application 110 operating on user device 102 can generally be an application that implements a service, such as services 120A-N. When a user interacts with an application implementing a service, the data is then communicated to the service via a corresponding data source, such as data sources 124A-N, 126A-N, 134A-N, or 136A-N. In some implementations, the application 110 comprises a web application, which can run in a web browser, and could be hosted at least partially server-side. In addition, or instead, the application 110 can comprise a dedicated application. In some cases, the application 110 is integrated into the operating system (e.g., as a service).

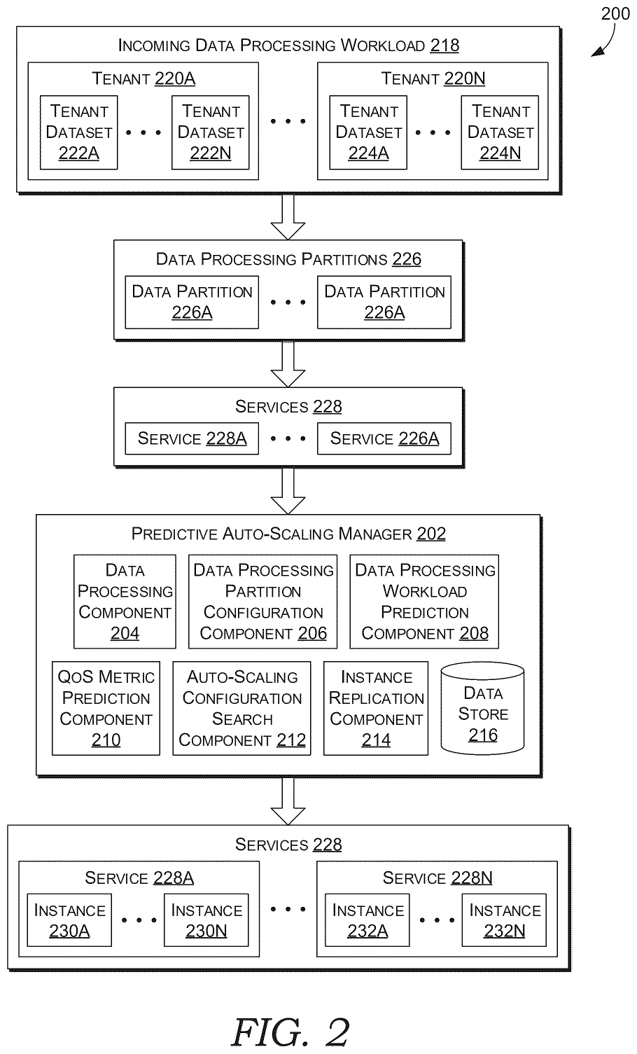

At a high level, predictive auto-scaling manager 108 performs various functionality to facilitate efficient and effective auto-scaling computing resource instances of a service for a predicted workload. The predictive auto-scaling manager 108 can communicate with services 120A-N to determine a predicted workload based on incoming data traffic from data sources 124A-N, 126A-N, 134A-N, or 136A-N. The predictive auto-scaling manager 108 can communicate with services 120A-N to auto-scale computing resource instances of services 120A-N. Predictive auto-scaling manager 108 can be or include a server, including one or more processors, and one or more computer-readable media. The computer-readable media includes computer-readable instructions executable by the one or more processors. The instructions can optionally implement one or more components of predictive auto-scaling manager 108, described in additional detail below with respect to predictive auto-scaling manager 202 of FIG. 2.

In operation, predictive auto-scaling manager 108 facilitate determining the optimal number of computing resource instances of services 120A-N to comply with a given quality service metric based on a predicted workload based on incoming data traffic from data sources 124A-N, 126A-N, 134A-N, or 136A-N in order to dynamically adjust the number of computing resource instances. For example, an incoming data processing workload, such as an incoming data ingestion workload is predicted by predictive auto-scaling manager 108 based on incoming data traffic from data sources 124A-N, 126A-N, 134A-N, or 136A-N. In some embodiments, the incoming data processing workload is predicted by predictive auto-scaling manager 108 using a hierarchical time-series forecasting method. For example, the hierarchal time-series forecasting method implemented by predictive auto-scaling manager 108 uses a number of hierarchal time-series levels, where one hierarchal time-series level is based on individual data sources 124A-N, 126A-N, 134A-N, or 136A-N, one hierarchal time-series level for each tenant 122A-N and 132A-N, and one hierarchal time-series level for the total traffic of each of the services 120A-N (e.g., and/or a level for each data resource grouping (e.g., live data, backfill data, etc.) of each service). Each of the hierarchal time-series levels are reconciled by predictive auto-scaling manager 108 into the hierarchal time-series level for the total traffic of the service (e.g., and/or each data resource grouping of the service). In some embodiments, external data can be used by predictive auto-scaling manager 108 in addition to the incoming data traffic to predict the incoming data processing workload. For example, data regarding traffic from upstream services, such as interconnected microservices (e.g., predicting instances of service 120N based on data traffic of service 120A), and/or other external data of the tenant, such as historical data or calendar data, can be used in addition to the incoming data traffic to predict the incoming data processing workload.

Using the predicted incoming data processing workload, a QoS metric, such as latency, of the service (e.g., or multiple services) can be predicted by predictive auto-scaling manager 108 based on the number of computing resource instances of the services 120A-N. In some embodiments, the QoS metric can be predicted by predictive auto-scaling manager 108 using a queuing model that models the arrival process and service process of incoming data traffic by the number of computer resource instances of the services 120A-N using probability distributions determined from historical data traffic and QoS measurements. In some embodiments, the QoS metric can be predicted by predictive auto-scaling manager 108 using a regression model, such as a HGBR, determined (e.g., trained using) from historical data traffic and QoS measurements.

The number of computing resource instances of the services 120A-N can be dynamically adjusted by predictive auto-scaling manager 108 to comply with a given QoS metric based on the predicted incoming data processing workload. For example, if the predicted QoS metric is below the given QoS metric threshold, the number of computing resource instances of the service can be increased by predictive auto-scaling manager 108 to meet or exceed the given QoS metric threshold. If the predicted QoS is above the given QoS metric threshold, the number of computing resource instances of the service can be decreased by predictive auto-scaling manager 108 while still meeting or exceeding the given QoS metric threshold to decrease computational costs. In some embodiments, a search algorithm is used by predictive auto-scaling manager 108 to determine the optimal number (e.g., or near optimal within a threshold) of computing resource instances of the services 120A-N that complies with the given QoS metric, such as by using a brute-force configuration search and/or a search optimization technique, such as a combinatorial search algorithm (e.g., hill climbing, beam search, simulated annealing, genetic algorithms, open-loop control and oscillation, and/or others).

As can be understood from predictive auto-scaling example 106, the number of computing resource instances of the services 120A-N can be dynamically adjusted by predictive auto-scaling manager 108 to comply with a given QoS metric based on the predicted incoming data processing workload in order to dynamically adjust the number of computing resource instances of the service with enough time to auto-scale the service before the predicted incoming data processing workload is processed.

Referring to FIG. 2, aspects of an illustrative predictive auto-scaling management system 200 are shown, in accordance with various embodiments of the present disclosure. At a high level, predictive auto-scaling management system 200 can facilitate auto-scaling computing resource instances of a service for a predicted workload by determining the optimal number of computing resource instances of a service that comply with a given quality service metric based on the predicted workload in order to dynamically adjust the number of computing resource instances.

As shown in FIG. 2, predictive auto-scaling manager 202 includes data processing component 204, data processing partition configuration component 206, data processing workload prediction component 208, QOS metric prediction component 210, auto-scaling configuration search component 212, and instance replication component 214. As an example, an incoming data processing workload 218 is received. For example, the incoming data processing workload 218, such as an incoming data ingestion workload, includes tenant datasets 222A-222N for tenant 220A and tenant datasets 224A-224N for tenant 220N from different data sources of each tenant (e.g., data sources 124A-N, 126A-N, 134A-N, and 136A-N of FIG. 1). The incoming data processing workload 218 is partitioned based on the data resource grouping of the data (e.g., live data, backfill data, etc.) into data partitions 226A-226N of data processing partitions 226. The incoming data processing workload 218 is then processed by respective services 228A-228N of services 228. The predictive auto-scaling manager 202 determines the optimal number of computing resource instances 230A-230N and 232A-232N of each service 228A-228N of the services 228 in order to comply with a given quality service metric based on a predicted workload in order to dynamically adjust the number of computing resource instances 230A-230N and 232A-232N of each service 228A-228N of the services 228.

The predictive auto-scaling manager 202 can communicate with the data store 216. The data store 216 is configured to store various types of information accessible by predictive auto-scaling manager 202, or other server or component. The foregoing components of predictive auto-scaling manager 202 can be implemented, for example, in operating environment 100 of FIG. 1. In particular, those components may be integrated into any suitable combination of user devices 102 and/or predictive auto-scaling manager 108.

In embodiments, data sources (e.g., data sources 124A-N, 126A-N, 134A-N, and 136A-N of FIG. 1), user devices (such as user device 102 of FIG. 1), and predictive auto-scaling manager 202 can provide data to the data store 216 for storage, which may be retrieved or referenced by any such component. As such, the data store 216 can store computer instructions (e.g., software program instructions, routines, or services), data and/or models used in embodiments described herein. In some implementations, data store 216 can store information or data received or generated via the various components of predictive auto-scaling manager 202 and provides the various components with access to that information or data, as needed. The information in data store 216 may be distributed in any suitable manner across one or more data stores for storage (which may be hosted externally).

The data processing component 204 is generally configured to monitor incoming data traffic for processing by each of the services 228. In embodiments, data processing component 204 can include rules, conditions, associations, models, algorithms, or the like to monitor incoming data traffic for processing by each of the services 228. The data processing partition configuration component 206 is generally configured to provide data processing partitions 226 (e.g., bulkheads) for the incoming data processing workload 218 for each of the services 228. In embodiments, data processing partition configuration component 206 can include rules, conditions, associations, models, algorithms, or the like to provide data processing partitions 226 (e.g., bulkheads) for the incoming data processing workload 218 for each of the services 228.

The data processing workload prediction component 208 is generally configured to determine the predicted incoming data processing workload for the services 228 based on the incoming data processing workload 218. In embodiments, data processing workload prediction component 208 can include rules, conditions, associations, models, algorithms, or the like to determine the predicted incoming data processing workload for the services 228 based on the incoming data processing workload 218. For example, data processing workload prediction component 208 may comprise a statistical model, fuzzy logic, neural network, finite state machine, support vector machine, logistic regression, clustering, or machine-learning techniques, similar statistical classification processes, or combinations of these to determine the predicted incoming data processing workload for the services 228 based on the incoming data processing workload 218.

The QoS metric prediction component 210 is generally configured to determine the predicted QoS metric for the services 228 based on the incoming data processing workload 218. In embodiments, QoS metric prediction component 210 can include rules, conditions, associations, models, algorithms, or the like to determine the predicted QoS metric for the services 228 based on the incoming data processing workload 218. For example, QoS metric prediction component 210 may comprise a statistical model, fuzzy logic, neural network, finite state machine, support vector machine, logistic regression, clustering, or machine-learning techniques, similar statistical classification processes, or combinations of these to determine the predicted QoS metric for the services 228 based on the incoming data processing workload 218.

The auto-scaling configuration search component 212 is generally configured to determine the optimal number of computing resource instances (e.g., 230A-230N of service 228A and 232A-232N of service 228N) of services 228 to comply with a given quality service metric. In embodiments, auto-scaling configuration search component 212 can include rules, conditions, associations, models, algorithms, or the like to determine the optimal number of computing resource instances of services 228 to comply with a given quality service metric. For example, auto-scaling configuration search component 212 may comprise a statistical model, fuzzy logic, neural network, finite state machine, support vector machine, logistic regression, clustering, or machine-learning techniques, similar statistical classification processes, or combinations of these to determine the optimal number of computing resource of services 228 to comply with a given quality service metric.

The instance replication component 214 is generally configured to dynamically adjust the number of computing resource instances (e.g., 230A-230N of service 228A and 232A-232N of service 228N) of services 228. In embodiments, instance replication component 214 can include rules, conditions, associations, models, algorithms, or the like to dynamically adjust the number of computing resource instances of services 228.

In embodiments, data processing component 204 monitors incoming data processing workload 218. Data processing partition configuration component 206 partitions the incoming data processing workload 218 into data processing partitions 226 (e.g., bulkheads) for each service (e.g., or bulkheads of multiple interconnected services).

An incoming data processing workload is predicted by data processing workload prediction component 208. Any known prediction technique can be used to predict the incoming data processing workload by data processing workload prediction component 208. In some embodiments, the incoming data processing workload is predicted by data processing workload prediction component 208 using a hierarchical time-series forecasting method, such as through a top-down, bottom-up, middle-out, and/or a reconciliation approach.

As an example, a multi-tenant infrastructure of a cloud computing system collects an aggregated flow from traffic from multiple tenants 220A-N and the incoming data processing workload 218 is monitored by data processing component 204. Within each tenant, there are multiple data sources (e.g., data sources 124A-N, 126A-N, 134A-N, and 136A-N of FIG. 1) that are generating the data traffic for the data processing workload 218. In this regard, the hierarchal time-series forecasting method implemented by data processing workload prediction component 208 can detect incoming data traffic and predict the incoming data processing workload using a number of hierarchal time-series levels. For example, the hierarchal time-series levels can include a hierarchal time-series level based on individual data sources of the tenant datasets 222A-222N for tenant 220A and tenant datasets 224A-224N for tenant 220N, a hierarchal time-series level for each tenant 220A-N, and a hierarchal time-series level for the total traffic of each service 228A-228N. As another example, the hierarchal time-series levels can include a hierarchal time-series level based on individual data sources of the tenant datasets 222A-222N for tenant 220A and tenant datasets 224A-224N for tenant 220N, a hierarchal time-series level for each tenant 220A-N, a hierarchal time-series level for each data resource grouping of data partitions 226A-226N of data processing partitions 226, such as live data, backfill data, etc., of the service, and/or a hierarchal time-series level for the total traffic of each service 228A-228N. As yet another example, the hierarchal time-series levels can include a hierarchal time-series level based on individual data sources of the tenant datasets 222A-222N for tenant 220A and tenant datasets 224A-224N for tenant 220N, a hierarchal time-series level for each tenant 220A-N, and a hierarchal time-series level for each data resource grouping of each data partitions 226A-226N of data processing partitions 226 of each service 228A-228N (e.g., in order to auto-scale computer resource instances of the portions of each service 228A-228N that facilitate data processing of each data resource grouping of each data partitions 226A-226N based on the QoS requirements of each data resource grouping of each data partitions 226A-226N).

An example of hierarchy of data sources is shown in FIG. 4A. As can be understood from diagram 400A, the bulkhead and/or service level is at the most aggregated level of the hierarchal time-series forecasting method followed by the tenant level and the data source level at the most granular level. An example of the incoming data ingestion workload of the hierarchy of data sources of FIG. 4A is shown in FIG. 4B. As can be understood from diagram 400B, the bulkhead and/or service level is at the most aggregated level of the hierarchal time-series forecasting method followed by the tenant level and the data source level at the most granular level.

In some embodiments, a reconciliation approach can be utilized by data processing workload prediction component 208, such as by building the time-series forecasting models independently at each level using a SARIMAX model, reconciling the individual forecasts, such as through a linear regression model (e.g., where individual forecasts are derived as weighted sums of forecasts from all hierarchy levels), and using the harmonized model at the top level to forecast the aggregated traffic of the system will experience in the near future. An example of a predicted incoming data ingestion workload with respect to a ground truth incoming data ingestion workload of FIG. 4B is shown in FIG. 4C. As can be understood from diagram 400C, the predictions are reconciled to the most aggregated level of the hierarchal time-series forecasting method.

In some embodiments, a data resource grouping level is used by data processing workload prediction component 208 in the hierarchal time-series levels of the hierarchal time-series forecasting method in order to auto-scale computer resource instances of the portions of the service that facilitate data processing of each data resource grouping based on the QoS requirements of each data resource grouping. For example, live data may require a higher latency QoS metric when processing the live data as opposed to backfill data (e.g., live traffic must be processed within a few hours and backfill data must be processed within 30 days, so the backfill data can be processed during off-peak times). The data resource groupings can be isolated using data processing partitions of the service by data processing partition configuration component 206. In this regard, a different number of computer resource instances of the service may be implemented at each bulkhead of the service by instance replication component 214 to facilitate data processing of each data resource grouping based on the QoS requirements of each data resource grouping.

In some embodiments, external data can be used by data processing workload prediction component 208 in addition to the incoming data traffic to predict the incoming data processing workload. For example, data regarding traffic from upstream services, such as interconnected microservices, and/or other external data of the tenant, such as historical data or calendar data, can be used by data processing workload prediction component 208 in addition to the incoming data traffic to predict the incoming data processing workload. In some embodiments, events can be manually input into by data processing workload prediction component 208 (e.g., via user device 102 of FIG. 1). In some embodiments, a calendar can be converted into a time-series by data processing workload prediction component 208 in order for the hierarchal time-series forecasting method to utilize data traffic of previous events (e.g., similar events) to predict the data processing workload of future events.

Using the predicted incoming data processing workload, a QoS metric, such as latency, throughput, and/or other QoS metrics, of the service (e.g., or multiple services) can be predicted by QoS metric prediction component 210 based on the number of computing resource instances of the service. Any known prediction technique can be used to predict the performance of the system based on the number of computing resource instances of the service.

In some embodiments, the QoS metric can be predicted by QoS metric prediction component 210 using a queuing model that models the arrival process and service process of incoming data traffic by the number of computer resource instances of the service using probability distributions determined from historical data traffic and QoS measurements. An example of a queuing model is shown in FIG. 5A. As can be understood, a queuing model of an abstraction of queue and processors is used to represent the various components inside the systems (e.g., CPU, and Network I/O). The system can then be analyzed using queuing theory. As can be understood from diagram 500A, the queuing model can model an arrival process representing how traffic enter the system over time, such as by using probability distributions to describe the inter-arrival times between entities. The queuing model can model a service process representing how traffic are processed or served by the system, such as by using probability distributions to describe the service times for entities. The queuing model can model queue discipline that determines the order in which entities are served from the waiting line, such as whether the queue discipline uses FIFO, LIFO, Priority Queuing, etc. The queuing model can model the number of servers or service facilities in the system (e.g., more servers generally reduces wait times and improves system throughput). The queuing model can model queue capacity representing the maximum number of entities that can be accommodated in the waiting line or queue before the entities are turned away or blocked. The queuing model can model can use queuing theory to determine various performance metrics to evaluate the system's efficiency and effectiveness, including average waiting time, average queue length, system throughput, utilization rate of servers, and probability of waiting. With respect to diagram 500A, B generally refers to an estimation of the backlog of queue, u generally refers to an estimation of the processing speed, W generally refers to an estimation of waiting time, S generally refers to an estimation of processing time, and T generally refers to an estimation of total latency. In some embodiments, the variables are determined by studying the characteristics of the system. In some embodiments, the variables are determined by fitting the arrival/departure traffic to a stochastic process (e.g., Poisson process).

Returning to FIG. 2, in some embodiments, the QoS metric can be predicted by QoS metric prediction component 210 using a regression model determined (e.g., trained using) from historical data traffic and QoS measurements. Any known regression model can be used to predict the QoS metric. In some embodiments, HGBR is used to predict the QoS metric based on the number of computing resource instances of the service. For example, a HGBR regressor of QoS metric prediction component 210 can be trained to predict the average latency of the system using input variables, such as the size and number of rows of each batch of data, number of computing resource instances of a service per bulkhead, queuing time, utilization, number of in-flight batches, and/or others.

An example of predicting the latency of a service for a data ingestion workload based on the number of computing resource instances of the service with respect to ground truth latency for the number of computing resource instances is shown in FIG. 5B. As can be understood from diagram 500B, the predicted data ingestion workload of diagram 400C of FIG. 4C is used to predict the corresponding latency based on the number of computing resource instances of the service.

Returning to FIG. 2, the number of computing resource instances of the service (e.g., or the number of computing resource instances each service of multiple services) can be dynamically adjusted by instance replication component 214 to comply with a given QoS metric based on the predicted incoming data processing workload by determining the optimal number of computer resource instances of the service by auto-scaling configuration search component 212. For example, if the predicted QoS metric is below the given QoS metric threshold, the number of computing resource instances of the service can be increased by instance replication component 214 to meet or exceed the given QoS metric threshold. If the predicted QoS is above the given QoS metric threshold, the number of computing resource instances of the service can be decreased by instance replication component 214 while still meeting or exceeding the given QoS metric threshold to decrease computational costs. In some embodiments, the number of computing resource instances of the service (e.g., or the number of computing resource instances each service of multiple services) can be dynamically adjusted by instance replication component 214 at each bulkhead to comply with a given QoS metric of each bulkhead based on the predicted incoming data processing workload for each bulkhead.

In some embodiments, a search algorithm is used by auto-scaling configuration search component 212 to determine the optimal number (e.g., or near optimal within a threshold) of computing resource instances of the service that complies with the given QoS metric For example, if the given latency limit is 100 ms, the goal of the search algorithm is to find the minimum number of computing resource instances that are estimated to process the traffic within 100 ms (e.g., or a threshold amount above of the given latency, such as 50% above the latency). Any known search technique can be used by auto-scaling configuration search component 212 to determine the optimal number of computing resource instances of the service (e.g., or the number of computing resource instances each service of multiple services).

In some embodiments, a brute-force configuration search is used by auto-scaling configuration search component 212 to determine the optimal number of computing resource instances of the service. In some embodiments, a search optimization technique, such as a combinatorial search algorithm (e.g., hill climbing, beam search, simulated annealing, genetic algorithms, open-loop control and oscillation, and/or others), is used by auto-scaling configuration search component 212 to determine the optimal number of computing resource instances of the service.

An example diagram of determining the optimal number of computing resource instances of the service is shown in FIG. 3. As can be understood from diagram 300, historical batch data 302 is input into the workload forecaster 304 (e.g., data processing workload prediction component 208 of FIG. 2). The workload forecaster 304 predicts the incoming workload in the future 306, which is provided to performance predictor 310 (e.g., QOS metric prediction component 210 of FIG. 2). The current system status 308 (e.g., the number of instances of the service) is also provided to performance predictor 310 in order to determine the predicted latency 312 of the current configuration of the services. A determination is made based on the predicted latency 312 and the thresholds from the SLA 314, such as a given QoS metric requirement, whether to scale out 316 (e.g., scale up and increase the number of instances), scale in 318 (e.g., scale down and reduce the number of instances), or maintain the current configuration. A configuration search is performed (e.g., auto-scaling configuration search component 212) and different system configurations 322 with different numbers of instances of the services are provided to the performance predictor 310 to determine the predicted latency 312 of the different system configurations. When a system configuration is determined at block 324 that complies with the threshold from the SLA 314 with a minimum number of instances (e.g., or close to the minimum number of instances based on processing capabilities), the system configuration is set as the final configuration 326 for the incoming workload in the future 306. In this regard, the optimal number of computing resource instances of a service that comply with a given quality service metric based on a predicted workload can be determined in order to auto-scale the computing resource instances of a service for a predicted workload

An example of auto-scaling the number of computing resource instances to comply with a given quality service metric corresponding to a latency of 2.3 seconds based on a predicted workload is shown in FIG. 6. As can be understood from diagram 600, the overall number of computing resource instances deployed for a service is reduced over the given time period, thereby conserving computing resources while still meeting the QoS metric requirement of an SLA.

Returning to FIG. 2, in some embodiments, the predicted incoming data processing workload is periodically determined by data processing partition configuration component 206 (e.g., a query is made to determine the predicted incoming data processing workload every five minutes) in order to dynamically adjust the number of computing resource instances of the service by instance replication component 214 at scheduled periodic intervals. In some embodiments, the optimal number (e.g., or near optimal within a threshold) of computing resource instances of the service is periodically determined (e.g., a query is made to determine the optimal number of computer resource instances every fifteen minutes) by auto-scaling configuration search component 212 in order to dynamically adjust the number of computing resource instances of the service by instance replication component 214 at scheduled periodic intervals with enough time to auto-scale the service before the predicted incoming data processing workload is processed, such as through ingestion. In some embodiments, the predicted incoming data processing workload is determined by data processing partition configuration component 206 and/or the optimal number of computing resource instances is determined by auto-scaling configuration search component 212 when incoming data traffic increases by a threshold amount in order to dynamically adjust the number of computing resource instances of the service by instance replication component 214.

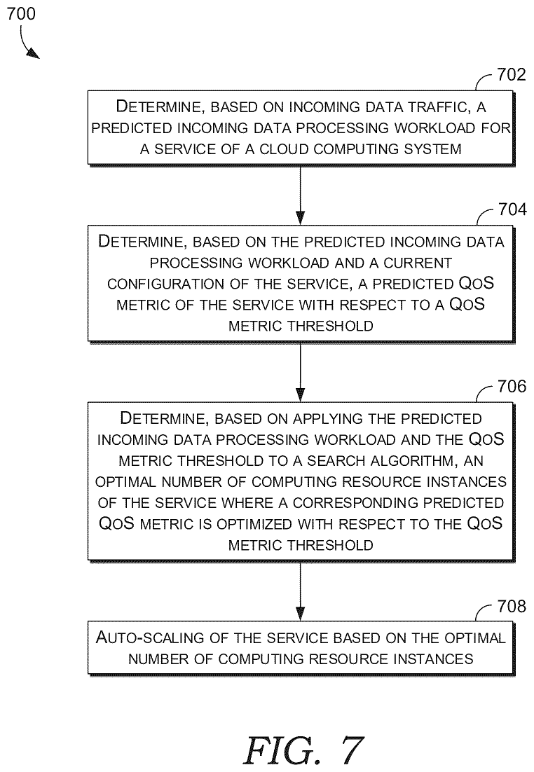

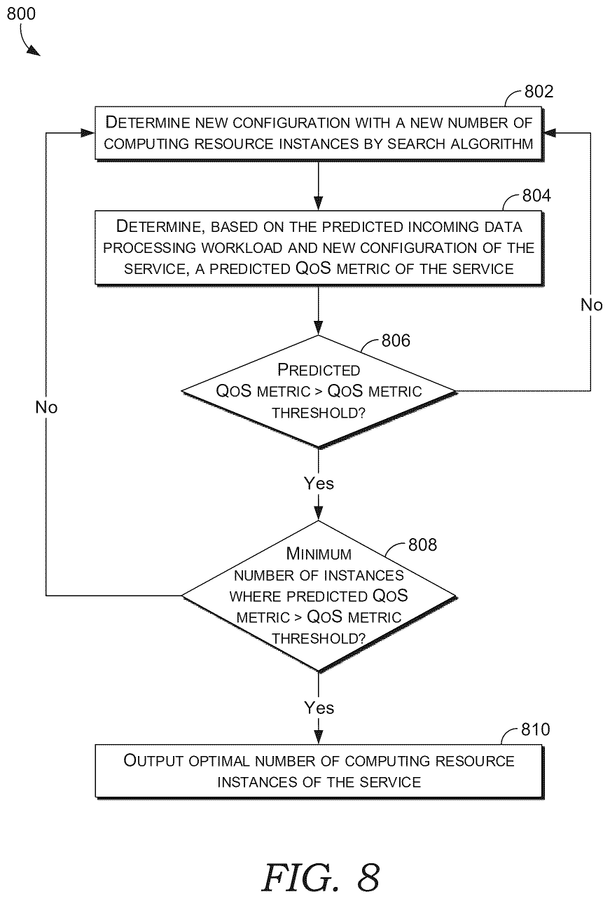

With reference now to FIGS. 7-8, FIGS. 7-8 provide method flows related to facilitating auto-scaling computing resource instances of a service for a predicted workload, in accordance with embodiments of the present technology. Each block of method 700 and 800 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 7-8 are exemplary only and not intended to be limiting. As can be appreciated, in some embodiments, method flows 700-800 can be implemented, at least in part, to facilitate auto-scaling computing resource instances of a service for a predicted workload.

Turning now to FIG. 7, a flow diagram 700 is provided showing an embodiment of a method 700 for auto-scaling computing resource instances of a service for a predicted workload, in accordance with embodiments described herein. Initially, at block 702, a predicted incoming data processing workload for a service (e.g., or each service of multiple services) of a cloud computing system is determined based on incoming data traffic (e.g., as described with respect to data processing workload prediction component 208 of FIG. 2). In some embodiments, a hierarchal time-series forecasting method is used to predict the predicted incoming data processing workload based on the incoming data traffic. In some embodiments, the incoming data traffic is accessed comprising a data source level corresponding to the incoming data traffic to each data source of a plurality of data sources, a tenant level corresponding to the incoming data traffic to each tenant of a plurality of tenants, and a service level corresponding to the incoming data traffic to the service. The predicted incoming data processing workload is then determined using a reconciliation approach for corresponding predictions of the data source level, the tenant level and the service level. In some embodiments, the predicted incoming data processing workload is determined based on an upstream service and/or external data of a tenant.

At block 704, a predicted QoS metric of the service (e.g., or each service of multiple services) with respect to a QoS metric threshold is determined based on the predicted incoming data processing workload and a current configuration of the service comprising a number of instances of the service (e.g., as described with respect to QoS metric prediction component 210 of FIG. 2). In some embodiments, a queuing model that models an arrival process and a service process of the incoming data traffic based on the number of computer resource instances of the service using probability distributions (e.g., as determined from historical data traffic and QoS measurements) is used to determine the predicted QoS metric. In some embodiments, a regression model, such as HGBR, is used to determine the predicted QoS metric.

At block 706, an optimal number of computing resource instances of the service (e.g., or each service of multiple services) where a corresponding predicted QoS metric is optimized with respect to the QoS metric threshold is determined based on applying the predicted incoming data processing workload and the QoS metric threshold to a search algorithm (e.g., as described with respect to auto-scaling configuration search component 212 of FIG. 2). In some embodiments, the search algorithm optimizes the corresponding number of computing resource instances of the service based on the predicted incoming data processing workload and the QoS metric threshold using a brute-force configuration search. In some embodiments, the search algorithm optimizes the corresponding number of computing resource instances of the service based on the predicted incoming data processing workload and the QoS metric threshold using a search optimization technique, such as a combinatorial search algorithm (e.g., a hill climbing algorithm, a beam search algorithm, a simulated annealing algorithm, a genetic algorithm, an open-loop control and oscillation algorithm, and/or others).

At block 708, the service is auto-scaled based on the optimal number of computing resource instances. In this regard, the number of computing resource instances of a service can be dynamically adjusted to comply with a given QoS metric based on a predicted workload.

Turning now to FIG. 8, a flow diagram 800 is provided showing an embodiment of a method 800 for auto-scaling computing resource instances of a service for a predicted workload by determining the optimal number of computing resource instances of a service that comply with a given quality service metric based on the predicted workload in order to dynamically adjust the number of computing resource instances, in accordance with embodiments described herein. Initially, at block 802, the search algorithm (e.g., as described with respect to block 706 of FIG. 7) determines new configuration of a service (e.g., or each service of multiple services) with a new number of computing resource instances. In some embodiments, the search algorithm determines the new configuration using a brute-force configuration search. In some embodiments, the search algorithm determines the new configuration using a search optimization technique, such as a combinatorial search algorithm (e.g., a hill climbing algorithm, a beam search algorithm, a simulated annealing algorithm, a genetic algorithm, an open-loop control and oscillation algorithm, and/or others).

At block 804, a predicted QOS metric of the service (e.g., or each service of multiple services) is determined based on the predicted incoming data processing workload and new configuration of the service (e.g., as described with respect to block 704 of FIG. 7). In some embodiments, a queuing model that models an arrival process and a service process of the incoming data traffic based on the number of computer resource instances of the service using probability distributions (e.g., as determined from historical data traffic and QoS measurements) is used to determine the predicted QoS metric. In some embodiments, a regression model, such as HGBR, is used to determine the predicted QoS metric.

At block 806, if the predicted QoS metric fails to comply with the QoS metric threshold, a new configuration of the service (e.g., or each service of multiple services) is determined by the search algorithm at block 802. If the predicted QoS metric complies with the QOS metric threshold, at block 808, the search algorithm determines whether the new configuration includes the minimum number of instances where the predicted QoS metric complies with the QoS metric threshold. If the new configuration includes the minimum number of instances, a new configuration is determined by the search algorithm at block 802 to find the configuration with the minimum number of instances.

If the new configuration includes the minimum number of instances, at block 808, the optimal number of computing resource instances of the service (e.g., or each service of multiple services) is output where a corresponding predicted QoS metric of the number of computing resource instances of the service is optimized with respect to the QoS metric threshold. In this regard, the number of computing resource instances of a service can be dynamically adjusted based on the optimal number of computing resource instances to comply with a given QoS metric based on a predicted workload.

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein. Neither should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or nonvolatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built in.

Illustrative I/O components include a microphone, joystick, game pad, satellite dish, scanner, printer, display device, wireless device, a controller (such as a keyboard, and a mouse), a natural UI (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 900. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

What is claimed is:

1. One or more computer-readable media having a plurality of executable instructions embodied thereon, which, when executed by one or more processors, cause the one or more processors to perform a method comprising:
determining, based at least on incoming data traffic, a predicted incoming data processing workload for a service of a cloud computing system;
determining, based at least on the predicted incoming data processing workload and a current configuration of the service comprising a number of computing resource instances of the service, a predicted quality of service (QOS) metric of the service that is below a QoS metric threshold;
determining, based at least on applying the predicted incoming data processing workload and the QoS metric threshold to a search algorithm, a corresponding number of computing resource instances of the service where a corresponding predicted QoS metric is above the QoS metric threshold; and
causing auto-scaling of the service based on the corresponding number of computing resource instances.

2. The media of claim 1, wherein determining the predicted incoming data processing workload further comprises:
using a hierarchal time-series forecasting method to predict the predicted incoming data processing workload based on the incoming data traffic.

3. The media of claim 1, wherein determining the predicted incoming data processing workload further comprises:
accessing the incoming data traffic comprising a data source level corresponding to the incoming data traffic to each data source of a plurality of data sources, a tenant level corresponding to the incoming data traffic to each tenant of a plurality of tenants, and a service level corresponding to the incoming data traffic to the service; and
determining the predicted incoming data processing workload using a reconciliation approach for corresponding predictions of the data source level, the tenant level and the service level.

4. The media of claim 1, wherein determining the predicted incoming data processing workload further comprises:
determining the predicted incoming data processing workload based on at least one of an upstream service or external data of a tenant.

5. The media of claim 1, wherein determining the predicted QoS metric further comprises:
using a queuing model that models an arrival process and a service process of the incoming data traffic based on the number of computer resource instances of the service using probability distributions to determine the predicted QoS metric.

6. The media of claim 1, wherein determining the predicted QoS metric further comprises:
using Histogram-Based Gradient Boosting Regression Tree (HGBR) to determine the predicted QoS metric.

7. The media of claim 1, wherein the search algorithm optimizes the corresponding number of computing resource instances of the service based on the predicted incoming data processing workload and the QoS metric threshold using a brute-force configuration search.

8. The media of claim 1, wherein the search algorithm optimizes the corresponding number of computing resource instances of the service based on the predicted incoming data processing workload and the QoS metric threshold using a combinatorial search algorithm comprising at least one of a hill climbing algorithm, a beam search algorithm, a simulated annealing algorithm, a genetic algorithm, or an open-loop control and oscillation algorithm.

9. A computer-implemented method comprising:
determining, based at least on incoming data traffic, a predicted incoming data processing workload for a plurality of services of a cloud computing system;
determining, based at least on the predicted incoming data processing workload and a current configuration of the service comprising a number of computing resource instances of each of the plurality of services, a predicted quality of service (QOS) metric of the plurality of services that is below a QoS metric threshold;
determining, based at least on applying the predicted incoming data processing workload and the QoS metric threshold to a search algorithm, a corresponding number of computing resource instances of each of the plurality services where a corresponding predicted QoS metric is above the QoS metric threshold; and
causing auto-scaling of each of the plurality of services based on the corresponding number of computing resource instances.

10. The computer-implemented method of claim 9, wherein determining the predicted incoming data processing workload further comprises:
using a hierarchal time-series forecasting method to determine the predicted incoming data processing workload based on the incoming data traffic.

11. The computer-implemented method of claim 9, wherein determining the predicted incoming data processing workload further comprises:
accessing the incoming data traffic comprising a data source level corresponding to the incoming data traffic to each data source of a plurality of data sources, a tenant level corresponding to the incoming data traffic to each tenant of a plurality of tenants, and a service level corresponding to the incoming data traffic to each of the plurality of services; and
determining the predicted incoming data processing workload for each of the plurality of services using a reconciliation approach for corresponding predictions of the data source level, the tenant level and the service level.

12. The computer-implemented method of claim 9, wherein determining the predicted incoming data processing workload further comprises:
determining the predicted incoming data processing workload based on at least one of an upstream service or external data of a tenant.

13. The computer-implemented method of claim 9, wherein determining the predicted QoS metric further comprises:
using a queuing model that models an arrival process and a service process of the incoming data traffic based on the number of computer resource instances of each of the plurality of services using probability distributions to determine the predicted QoS metric.

14. The computer-implemented method of claim 9, wherein determining the predicted QoS metric further comprises:
using Histogram-Based Gradient Boosting Regression Tree (HGBR) to determine the predicted QOS metric.

15. The computer-implemented method of claim 9, wherein the search algorithm optimizes the corresponding number of computing resource instances of each of the plurality of services based on the predicted incoming data processing workload and the QoS metric threshold using a combinatorial search algorithm comprising at least one of a hill climbing algorithm, a beam search algorithm, a simulated annealing algorithm, a genetic algorithm, or an open-loop control and oscillation algorithm.

16. A computing system comprising:
a processor; and
a non-transitory computer-readable medium having stored thereon instructions that when executed by the processor, cause the processor to perform operations including:
determining, based at least on incoming data traffic, a predicted incoming data processing workload for a service of a cloud computing system;
determining, based at least on the predicted incoming data processing workload and a current configuration of the service comprising a number of computing resource instances of the service, a predicted quality of service (QOS) metric of the service that is above a QoS metric threshold;
determining, based at least on applying the predicted incoming data processing workload and the QoS metric threshold to a search algorithm, a reduced number of computing resource instances of the service where a corresponding predicted QoS metric remains above the QoS metric threshold; and
causing auto-scaling of the service based on the reduced number of computing resource instances.

17. The system of claim 16, wherein determining the predicted incoming data processing workload further comprises:
using a hierarchal time-series forecasting method to determine the predicted incoming data processing workload based on the incoming data traffic by:
accessing the incoming data traffic comprising a data source level corresponding to the incoming data traffic to each data source of a plurality of data sources, a tenant level corresponding to the incoming data traffic to each tenant of a plurality of tenants, and a service level corresponding to the incoming data traffic to the service; and
determining the predicted incoming data processing workload using a reconciliation approach for corresponding predictions of the data source level, the tenant level and the service level.

18. The system of claim 16, wherein determining the predicted incoming data processing workload further comprises:
determining the predicted incoming data processing workload based on at least one of an upstream service or external data of a tenant.

19. The system of claim 16, wherein determining the predicted QoS metric further comprises at least one of:
(1) using a queuing model that models an arrival process and a service process of the incoming data traffic based on the number of computer resource instances of the service using probability distributions to determine the predicted QoS metric or (2) using Histogram-Based Gradient Boosting Regression Tree (HGBR) to determine the QoS metric.

20. The system of claim 16, wherein the search algorithm optimizes the corresponding number of computing resource instances of the service based on the predicted incoming data processing workload and the QoS metric threshold using at least one a brute-force configuration search or a search optimization technique.
